(19) United States
(12) Patent Application Publication
(10) Pub. No.: US 2008/0220119 A1
(43) Pub. Date: Sep. 11, 2008

(54) CONFECTIONERY DEPOSITING APPARATUS AND PRODUCT AND METHOD OF PRODUCING SAME

(75) Inventors: Joan Fabre Fornaguera, Sant Cugat del Valles (ES); Marguerite L. Yang, Wilmette, IL (US); Maria Jesus Bengoetxea, Barcelona (ES)

Correspondence Address: BELL, BOYD & LLOYD LLP, P.O. Box 1135, CHICAGO, IL, 60690, US

(73) Assignee: WM. WRIGLEY JR. COMPANY, Chicago, IL (US)

(21) Appl. No.: 12/053,053

(22) Filed: Mar. 21, 2008

Related U.S. Application Data
(62) Division of application No. 10/933,954, filed on Sep. 3, 2004.

(51) Int. Cl. A23G 4/18; A23G 3/54

(52) U.S. Cl. 426/5; 426/103

(57) ABSTRACT

The present invention provides a confectionery depositing apparatus that deposits a layer or multiple layers of a flowable confectionery product with a high degree of accuracy. The apparatus includes a source of a flowable confectionery, a cylinder, and a rotary valve in fluid communication with the source of flowable confectionery, and the cylinder. Placement of the rotary valve in a first position permits the flowable confectionery into the cylinder and placement of the rotary valve in a second position permits dispensing of the flowable confectionery from the cylinder out of the apparatus. A piston in close operative engagement with the cylinder enables the apparatus to deposit precise amounts of confectionery product to produce thin uniform layers of confectionery product.

### BACKGROUND OF THE INVENTION

Multiple layer confectioneries enjoy widespread appeal. Confectionery consumers are attracted to candies having multiple layers, flavors and colors arranged in various creative designs and shapes. Systems for producing such multiple component confectionery articles typically utilize a depositing apparatus that injection deposits two or more fluid confectionery streams into a mold to form the confectionery article. Formation of multiple layer candies requires an ability to control production parameters such as confectionery intake amount and confectionery injection rate, for example.

Conventional depositing apparatuses used in the production of multiple layer candies, however, have several drawbacks. Customary gravity-feed arrangements for the fluid confectionery yield substantial inconsistency in the amount of confectionery drawn into the depositing apparatus. The confectionery deposit amount consequently varies significantly between deposit cycles. In addition, spring loaded depositing valves used in current depositing apparatuses are prone to sealing problems resulting in valve leakage and tailing. These and other shortcomings in the art lead to undesirable levels of product reject as uniformity in layer thickness cannot be controlled with a satisfactory degree of accuracy.

A need therefore exists for a confectionery depositing apparatus capable of producing multiple layered confectionery articles with a high degree of accuracy and control. A need further exists for a precision confectionery depositing apparatus capable of forming thin layers of confectionery product and thin coating layers in particular.

### SUMMARY OF THE INVENTION

The present invention provides a confectionery depositing apparatus and method that deposits one or more confectionery streams with an improved degree of control and accuracy. The present invention thereby provides an apparatus capable of depositing precise amounts of flowable confectionery product in layer form. The depositing apparatus of the present invention is particularly suited to form very thin uniform layers of confectionery product.

In an embodiment, the confectionery depositing apparatus includes a source of a flowable confectionery, a cylinder, and a rotary valve in fluid communication with the source of flowable confectionery, and the cylinder. Placement of the rotary valve in a first position permits the flowable confectionery into the cylinder and placement of the rotary valve in a second position permits dispensing of the flowable confectionery from the cylinder out of the apparatus. The rotary valve includes a channel that establishes fluid communication between the source and the cylinder when the rotary valve is in the first position and fluid communication between the cylinder and an outlet when the rotary valve is in the second position.

In an embodiment, the apparatus also includes a piston in cooperative or otherwise operational engagement with the cylinder. Movement of the piston in a first or upward direction transfers the flowable confectionery into the cylinder when the rotary valve is in the first position, and movement of the piston in a second or downward direction dispenses the flowable confectionery from the cylinder when the rotary valve is in the second position. In a further embodiment, a very small gap or no gap whatsoever is present between an exterior circumferential surface of the piston head and an interior circumferential surface of the cylinder. In the event a gap is present, the gap may have a length of from about 0 mm to 0.05 mm. This tight operative engagement between the piston and cylinder interior advantageously provides the apparatus of the present invention to accurately transfer an amount of confectionery from the source into the cylinder and subsequently deposit this amount from the apparatus. In an embodiment, the piston head remains in the cylinder during the movement of the piston. This advantageously provides the present invention with a substantially airtight confectionery intake arrangement.

In a further embodiment, the apparatus deposits successive amounts of confectionery articles. The weight variance between these successive amounts may be between from about 0.01% to about 1.0%.

In a further embodiment of the present invention, a confectionery depositing apparatus for producing a laminated confectionery article is provided. The apparatus includes a first source of a first flowable confectionary and a second source of a second flowable confectionary, a first cylinder and a second cylinder corresponding to the first and second sources respectively and a rotary valve in fluid communication with the first and second sources and the first and second cylinders. Placement of the rotary valve in a first position permits the transfer of the first confectionery and the second confectionery to the first and second cylinders respectively and placement of the rotary valve in a second position permits dispensing of the first confectionery and the second confectionery from the first and second cylinders respectively.

In an embodiment, the apparatus also includes a nozzle in fluid communication with the rotary valve. The nozzle may deposit the first and second confectionery into a mold having a diameter substantially equal in length with the diameter of the nozzle. This arrangement prevents the first and second confectionery streams from adversely commingling with each other. Alternatively, the length of the nozzle diameter and the mold diameter may be different to mix the confectionery streams as desired.

In an embodiment, the apparatus may also include a first piston and a second piston in cooperative operation with the first and second cylinders respectively. Movement of the first and second pistons in a first or upward direction transfers the first and second confectionery to the respective first and second cylinder when the rotary valve is in the first position. Movement of the pistons in a second or downward direction dispenses the first and second confectionery from the respective first and second cylinders into the nozzle when the rotary valve is in the second position. Consequently, the nozzle may be used to coextrude the first confectionery with the second confectionery when the rotary valve is in the second position. The coextruded first confectionery stream may encase the second confectionery stream.

In an embodiment, the first piston may be moved at a rate different than the rate of movement for the second piston. Alternatively, the piston head diameter, the stroke distance, and/or the confectionery density may be varied to coextrude different amounts of first and second confectioneries.

A method of producing a confectionery product is provided in yet a further embodiment of the present invention. The method includes providing a depositing apparatus having a rotary valve in fluid communication with a source of a flowable confectionary, a cylinder, and an outlet. An amount of the flowable confectionery may be transferred into the cylinder when the rotary valve is in a first position. The method includes dispensing the confectionery amount from the cylinder through the outlet when the rotary valve is in a second position. The method also entails moving the rotary valve between the first and second positions.

In an embodiment, the method includes moving a piston that is in operative engagement with the cylinder in a first or upward direction in order to transfer the amount of confectionery from the source into the cylinder. The piston may then be subsequently moved in a second or downward direction to discharge the amount from the cylinder when the rotary valve is move to the second position.

In an embodiment, the method includes determining the quantity of the first amount by moving the piston a first predetermined distance in the first direction and moving the piston the predetermined distance in the second direction to discharge the amount from the cylinder. The first predetermined distance and the second predetermined distance may be substantially equal. The method may further include dispensing successive amounts of confectionery product from the apparatus. The amounts may have a weight variance from about 0.01% to about 1.0%.

A method of producing a laminated confectionery product is provided in another embodiment of the present invention. The method includes providing a confectionery depositing apparatus having a rotary valve in fluid communication with a first source of a flowable confectionary and a corresponding first cylinder, a second source of a flowable confectionary and a corresponding second cylinder, and a nozzle. A first amount of the first confectionery and a second amount of the second confectionery are then transferred into the first and second cylinder respectively when the rotary valve is in a first position. The method includes coextruding the first and second amount from the nozzle when the rotary valve is in a second position to form a multilayered confectionary article. The quantity of the first and second amounts may be the same or different. The extrusion rate of the first and second amounts may be the same or different.

In an embodiment, the method may include discharging the first and second amounts from the respective first and second cylinders into the nozzle when the rotary valve is in the second position to encase the second amount with the first amount. The method may thereby include forming a coated confectionery article.

A further embodiment of the present invention provides a confectionery article. The confectionery article includes a core coextruded to a coating, the coating present in an amount from about 5% to about 30% by weight of the confectionery article. In an embodiment, the coating is substantially continuous and encases or otherwise surrounds the entire core. The composition of the coating and core may be the same or different. In an embodiment, the coating is a composition different than the core. In a further embodiment, coating is present from about 5% to about 10% by weight. In yet a further embodiment, the coating may have a thickness from about 0.05 mm to about 2.0 mm.

Additional features and advantages of the present invention are described in, and will be apparent from, the following Detailed Description of the Invention and the figures.

### BRIEF DESCRIPTION OF THE FIGURES

FIG. 1 is a perspective view of a confectionery depositing apparatus in accordance with the present invention.

FIG. 2 is a perspective view of the apparatus of FIG. 1 illustrating the inner components of the apparatus of the present invention.

FIG. 3 is a sectional view of the confectionery depositing apparatus taken along line 3-3 of FIG. 2.

FIG. 4 is a sectional view of the apparatus taken along line 4-4 of FIG. 2.

FIG. 5 is a perspective view of a manifold in accordance with the present invention.

FIG. 6 is a front elevational of the manifold of FIG. 5.

FIG. 7 is a perspective view of a rotary valve in accordance with the present invention.

FIG. 8 is a schematic representation of the confectionery deposing apparatus when the rotary valve is in a first position.

FIG. 9 is a schematic representation of the confectionery depositing apparatus when the rotary valve is in a first position.

FIG. 10 is a schematic representation of the confectionery depositing apparatus when the rotary valve is in a second position.

FIG. 11 is a schematic representation of the confectionery depositing apparatus when the rotary valve is in a second position.

FIG. 12 is a sectional view of a confectionery article produced in accordance with the present invention.

### DETAILED DESCRIPTION OF THE INVENTION

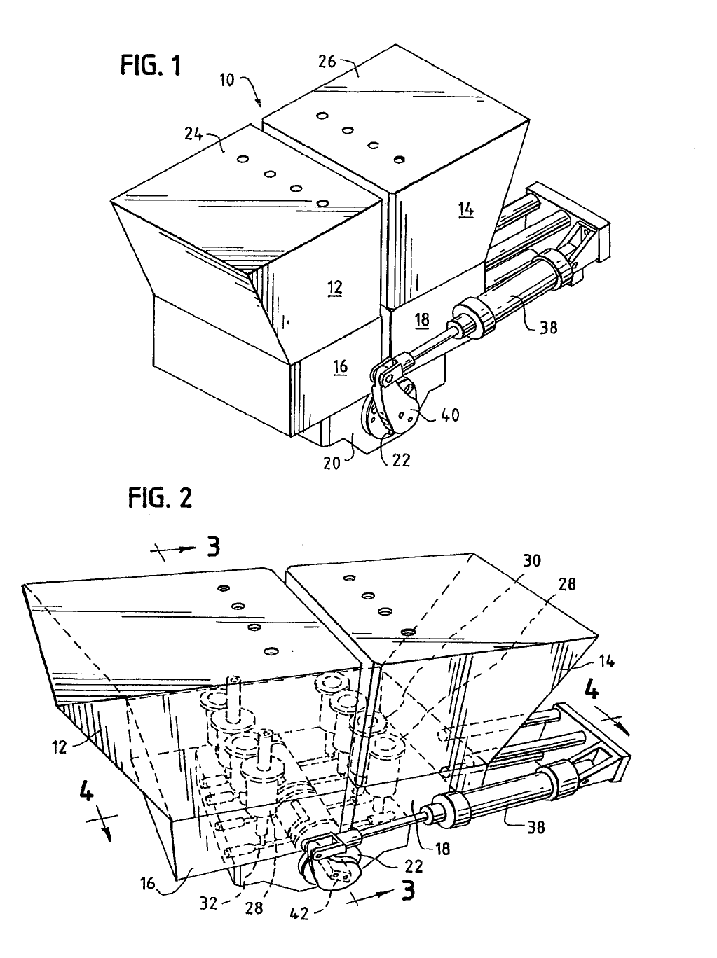

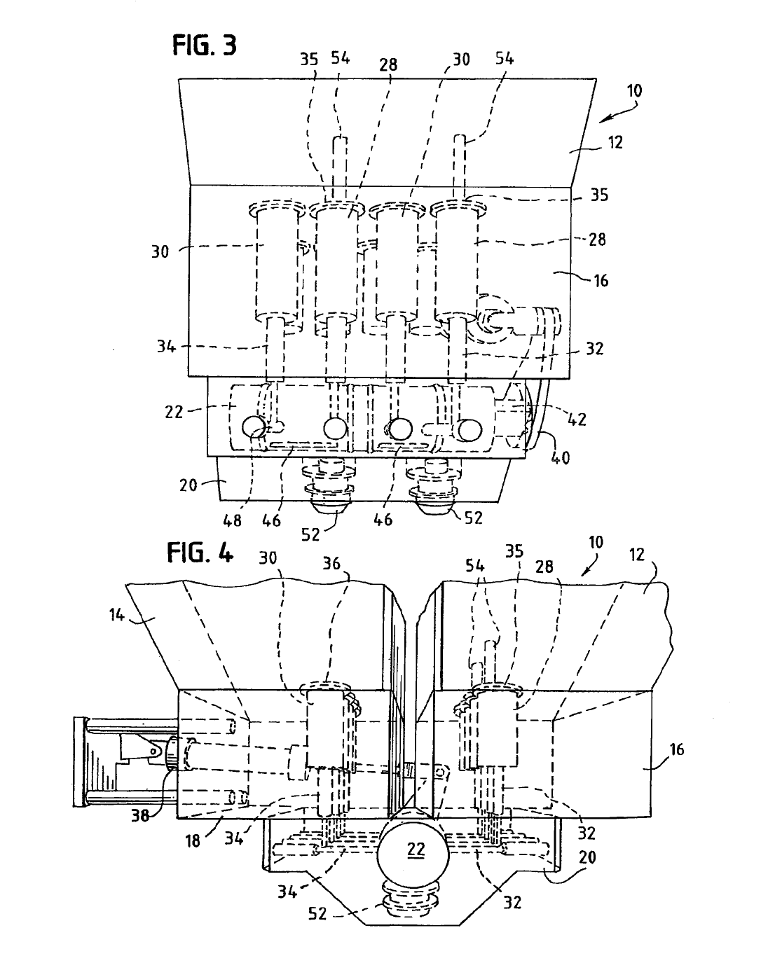

Referring to the Figures generally, where like reference numerals denote like structure and elements, and in particular to FIGS. 1-4, a confectionery depositing apparatus 10 for producing a confectionery product is shown in accordance with an embodiment of the present invention. Apparatus 10 includes confectionery sources 12 and 14, housings 16 and 18, and a manifold 20 having a rotary valve 22. Apparatus 10 is typically a component of a larger continuous confectionery production system that deposits a stream or streams of fluid or flowable confectionery into a plurality of individual molds moved into a depositing position by a continuous transporter such as a conveyor, for example. The system may also include a packaging stage as is commonly known in the art.

Confectionery sources 12 and 14 may be any container or reservoir suitably adapted to contain or otherwise hold a quantity of flowable confectionery product as is commonly known in the art, such as a hopper, for example. The confectionery product may be any confectionery substance, material, or compound that is a fluid or may take a flowable form. The confectionery product of the present invention may be a syrup or a liquid, for example. In addition, the confectionery product may be melted, or dissolved at a temperature above ambient to become flowable as is commonly known in the art. The skilled artisan will appreciate that the moisture content (and concomitant viscosity) of the confectionery product may vary greatly. The moisture content of the flowable confectionery is typically in the range of about 2% to about 12% by weight of the confectionery product. The flowable confectionery product may then be deposited into a mold or a shape-defining receptacle wherein the confectionery product subsequently solidifies at room temperature to form a solid confectionery article such as a hard candy, a soft candy, a chewing gum or combinations thereof. Nonlimiting examples of suitable confectionery products that are flowable or may placed into a flowable state include syrups, liquids or solids for making hard candies, soft candies, lollipops, fondants, toffees, jellies, chewing gums, chocolates, gelatins and nougats. The confectionery product of the present invention may include sugar or may be sugar-free. Coloring may be added to each confectionery product as desired. The confectionery product may also be substituted by a pharmaceutical product or a medicament that may prepared into a flowable state in a similar manner.

Apparatus 10 may include as few as a single confectionery source to as many as three, four, or five or more confectionery sources. Each confectionery source may include heating elements (not shown) to maintain the confectionery product in a flowable state. The sources may be adapted to maintain each confectionery product at the same or at different temperatures. Covers 24 and 26 may be removably attached to sources 12 and 14 respectively permitting addition of the confectionery product into each respective source. Covers 24 and 26 may then be used enclose the inner areas of each confectionery source in order to protect the confectionery product from contaminants. The confectionery product contained in sources 12 and 14 may the same or different. In an embodiment, each confectionery source contains a different confectionary product.

Sources 12 and 14 are in fluid communication with housings 16 and 18 as shown in FIGS. 2-4. Housings 16 and 18 include cylinders 28 and inlets 30. Each cylinder 28 is associated with a respective inlet 30 and may be put in fluid communication with the associated inlet as will be described in detail below. The cylinders and inlets are generally annular in shape. In an embodiment, cylinder 28 has an interior circumferential surface or wall that is substantially uniform (i.e., the inner cylinder wall has no openings thereon) defining an inner area or volume that is capable of holding a quantity of flowable confectionery product. The inlets and cylinders extend from the top surface of the housings into the interior of the housings. Bores 32 extend from a bottom opening of each cylinder through the housings and into manifold 20 providing fluid communication between each cylinder and rotary valve 22. Similarly, ducts 34 extend from a bottom opening of each inlet and extend through the housings and into manifold 20 placing each inlet in fluid communication with rotary valve 22.

The top of each piston includes a cylinder opening 35 and the top of each inlet includes an inlet opening 36. Inlet opening 36 is exposed to a lower area of the confectionery source thereby placing inlet opening 36 in fluid communication with the flowable confectionery product contained in sources 12 and 14. This configuration permits the flowable confectionery product to readily enter the inlets 30 and flow through a respective duct 34 to rotary valve 22. Each cylinder 28 is associated with or mated with a respective inlet 30. Each housing 16 or 18 may include from one cylinder/inlet pair to as many as five, 10, 20, or 30 or more cylinder/inlet pairs. It is understood that description of a single cylinder and/or inlet applies equally to each cylinder and/or inlet.

Although FIGS. 1-4 show confectionery sources 12 and 14 proximate to and abutting respective housings 16 and 18, it will be appreciated that the confectionery sources may be remote from each respective housing. In this embodiment, the confectionery source may be a reservoir or other receptacle suitable for holding the flowable confectionery product at a location remote from the housing. Piping may be used to fluidly connect the confectionery source with each inlet, for example.

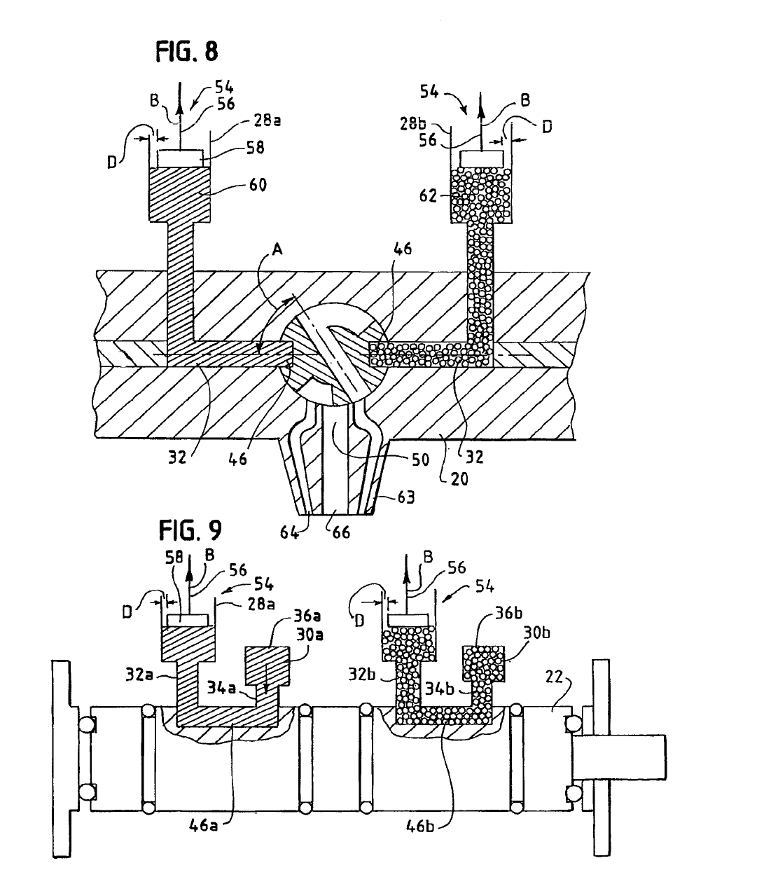

Referring to FIG. 1, a driving arm 38 powered by a power source (not shown) drives or otherwise propels a camber 40 which is connected to a support member 42 of rotary valve 22 to transfer the translational force imparted by arm 38 into a rotational force that actuates or otherwise rotates rotary valve 22. Extension and retraction of driving arm 38 thereby turns rotary valve 20 between a first position and a second position. The amount of extension and retraction of arm 38 may be adjusted as desired so that the rotational arc distance between the first position and the second position may be from about 5° to about 180°. In an embodiment, the arc distance between the first position and the second position is about 45°, as shown by arc segment A in FIG. 8.

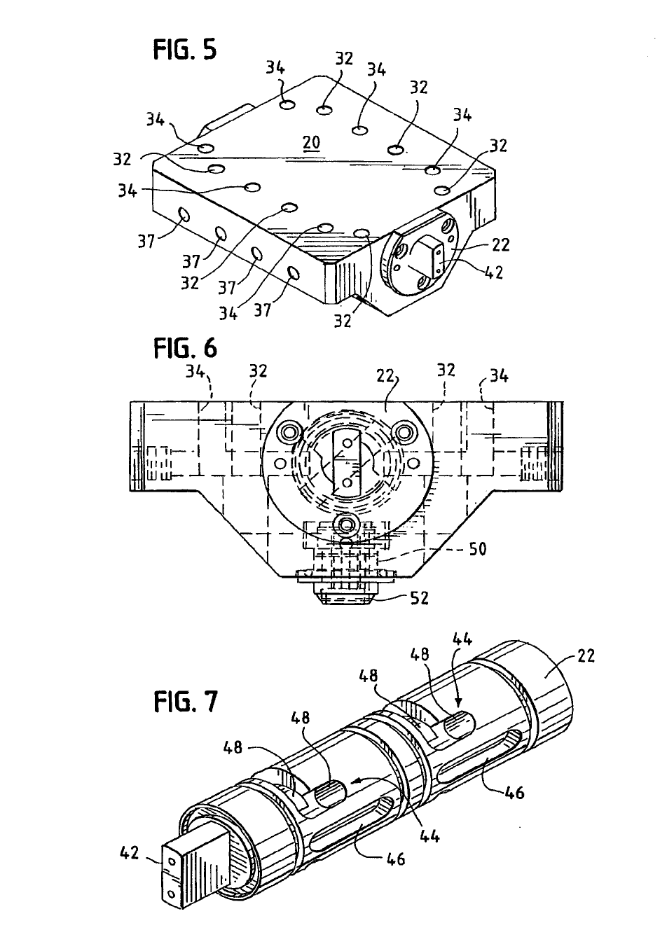

FIGS. 5-7 illustrate manifold 20 which houses rotary valve 22. Manifold 20 is adapted to permit rotary valve 22 to rotate or otherwise turn between a first transfer position and a second dispensing or depositing position. Bores 32 and ducts 34 from housings 16 and 18 extend into manifold 20 fluidly connecting the cylinders and inlets respectively to rotary valve 22. In an embodiment, manifold 20 may include ports 37 which are in fluid communication with bores 32, ducts 34, and rotary valve 22 in order to allow for cleaning or unclogging of the same.

In an embodiment, rotary valve 22 includes a channel 44 having a transfer passage 46 and a dispensing passage 48 as shown in FIG. 7. Transfer passage 46 fluidly connects bore 32 and duct 34 when the rotary valve is in the first position. This provides fluid communication between cylinder 28 and the corresponding inlet 30 associated with cylinder 28. Placement of rotary valve 22 in the first position thereby permits the flowable confectionery product to flow into the inner volume of cylinder 28. In particular, when rotary valve 22 is in the first position, the flowable confectionery flows from either source 12 or 14 into inlet 30 through duct 34, through transfer passage 46 into bore 32 and into the inner area of cylinder 28.

When the rotary valve is rotated or moved to the second position, dispensing passage 48 moves into fluid communication with cylinder 28 permitting the amount of flowable confectionary product present in cylinder 28 to be dispensed therefrom. In particular, when rotary valve 22 is in the second position, the flowable confectionery present within cylinder 28 flows into dispensing passage 48 and flows out from the bottom of manifold 20 through a manifold outlet 50 as shown in FIG. 6. In an embodiment, a nozzle 52 may be affixed to the underside of manifold 20 to be in fluid communication with manifold outlet 50. Thus, when rotary valve 22 is in the second position, nozzle 52 may deposit the flowable confectionery present in the cylinder into a mold as is commonly known in the art. Manifold 20 and rotary valve 22 are configured so that the transferring and dispensing of confectionery product occur independently of each other. For example, when rotary valve 22 in the first or transfer position, dispensing passage 48 is not in fluid communication with cylinder 28. Consequently, no confectionery product is dispensed or deposited from manifold 20 when rotary valve 22 is in the first position. In a similar manner, when rotary valve 22 is in the second, or depositing position, transfer passage 46 is not in fluid communication with cylinder 28 or inlet 30. Thus, no confectionery product is transferred when rotary valve is in the second position.

In an embodiment, a piston 54 is in operative engagement with a respective cylinder 28 as shown in FIGS. 2-4, 8 and 11. A piston shaft 56 extends through cylinder opening 35 and is operatively connected to a power source (not shown). Piston shaft 56 moves a piston head 58 in an up and down motion within the interior area of cylinder 28 as is commonly known in the art. A controller (not shown) may be operatively connected to driving arm 38 and the piston power source to coordinate or otherwise synchronize the movement of piston 54 and rotation of rotary valve 22.

In an embodiment, piston 54 may be moved in an upward direction when rotary valve 22 is in the first position as shown by arrow B in FIGS. 8 and 9. The upward motion of piston 54 creates a negative pressure within cylinder 28 which draws or otherwise transfers an amount of flowable confectionery product from source 12, through inlet opening 36 into inlet 30 through transfer passage 46, through bore 32 and into the interior volume of cylinder 28. Piston 54 may subsequently be moved in a downward direction when rotary valve is moved to the second position as shown by arrow C in FIG. 11. The downward motion of the piston forces the flowable confectionery product out of cylinder 28, through bore 32, through dispensing passage 48 and out of manifold 20 through manifold outlet 50. The amount of confectionery dispensed may vary corresponding to the distance piston head 58 is downwardly moved. If the downward distance of the piston is less than the upward distance of the piston, the amount of confectionery deposited will be less than the amount of confectionery transferred into the cylinder. In an embodiment, the length of the distance piston head 58 is moved in the upward direction and the downward direction is substantially equal so that the transferred amount of confectionery is substantially equal to the deposited amount of confectionery.

In an embodiment, a small gap D may be present between the exterior circumferential surface of piston head 58 and the interior circumferential surface of cylinder 28 as is shown in FIGS. 8, 9 and 11. Gap D, as best seen in FIG. 11, may have a length from about 0 mm to about 0.05 mm in length. In an embodiment, the length of the gap is from about 0.006 mm to about 0.035 mm. In a further embodiment, the gap has no length and no gap exists between the piston head outer surface and the cylinder inner surface. Teflon may be used to coat the piston head outer surface and/or the cylinder inner surface to maintain the tight fit between piston head and cylinder while simultaneously reducing friction therebetween.

The small length of gap D or the absence of the gap altogether and the concomitant tight fit between piston head 58 and the inner surface of cylinder 28 enables apparatus 10 to deposit confectionery product with a high degree of accuracy. Piston head diameter (and cylinder diameter), stroke length, and confectionery density may be varied as desired to desposit confectionery product with a high degree of precision. An advantage of the present invention is that the only significant factor influencing variance between deposit runs or batches is stroke variance. Consequently, the present invention provides deposited confectionery product or articles having a weight variance between successive deposit amounts from about 0.01% to 1% with successive deposit amounts typically experiencing less than 0.6% weight variance. This is a substantial improvement over conventional confectionery depositing systems which typically experience weight variance from about 10% to about 20% or more.

Not wishing to be bound by any particular theory, the significant improvement in depositing precision provided by the present invention may be partially due to the avoidance of a gravity feed system by the present invention. Conventional gravity-fed confectionery depositors require a wide tolerance between the piston head and the inner cylinder surface in order to provide adequate space for confectionery to flow into the cylinder. Removal of the piston head from the cylinder chamber during conventional piston upstroke further contributes to high weight variance between successive deposit amounts. Moreover, the presence of openings in the cylinder walls for confectionery product inflow further contributes to the low accuracy of current systems. Conventional gravity-fed depositors also require dwell time to allow the flowable confectionery to enter the cylinder. The present invention eliminates dwell time as the closed pressure-feed system requires very little time to fill the cylinder with confectionery. The tight fit between the piston head and the inner cylinder surface, the closed pressure-fed confectionery delivery system, and the rotary valve each contribute to provide a confectionery depositing apparatus with exceptional accuracy.

Rotary valve 22 also contributes to the accuracy of the amount of confectionery deposited by apparatus 10. It is commonly known in the art that once the flowable confectionery is deposited from the nozzle, a small amount of confectionery product, known as a tail, may remain suspended from the nozzle outlet. This tail may eventually fall into the formed confectionery article. The tail may also remain on the nozzle to be deposited during the next deposit cycle. Either event may cause undesired disparity between the weight, size and appearance of the finished confectionery article. In addition, the tail may further deleteriously impact the surface texture of the finished article and any coating layer in particular.

In an embodiment of the present invention, the pistons may be moved in the first upward direction a short distance once the confectionery product is discharged from each cylinder. This is performed while the rotary valve is in the second or dispensing position. In this manner, the tail may be pulled into the transfer passage of the rotary valve thereby preventing the tail from adversely affecting the confectionery article formed.

Alternatively, the movement of the pistons in the downward direction may be synchronized with returning the rotary valve to the first position. Immediately upon completion of depositing the confectionery product from the cylinder, the rotary valve may be moved back to the first position to prevent formation of the tail altogether. In a further embodiment, movement of the rotary valve from the second or depositing position back to the first or transfer position may be coordinated with the small movement of the piston in the upward direction to ensure capture of the tail within the transfer passage.

In a further embodiment of the present invention, apparatus 10 may be configured to deposit more than one flowable confectionery product in order to produce a laminated confectionery article. Apparatus 10 may be adapted to dispense a plurality of flowable confectionery products. The number of cylinders, inlets, bores, ducts may be increased to provide an increased number of layers for the confectionery article as desired. In addition, rotary valve 22 may be adapted to include multiple transfer and dispensing passages to transfer and dispense multiple flowable confectionery products. For example, FIG. 7 shows rotary valve 22 having two transfer passages 46 and two dispensing passages 48.

In this embodiment, a first flowable confectionery 60 (indicated by diagonal hash marks) contained in source 12 and a second flowable confectionery product 62 (indicated by small circles) contained in source 14 may be transferred to cylinders 28a and 28b respectively as shown in FIGS. 8 and 9. Upward motion of the pistons indicated by arrows B transfers the first flowable confectionery product 60 from source 12 and the second flowable confectionery product 62 from source 14 through bores 32a and 32b into cylinders 28a and 28b respectively through inlets 30a and 30b and ducts 34a and 34b respectively when rotary valve 22 is in the first or transfer position as previously discussed. FIG. 9 illustrates the fluid communication between cylinders 28a, 28b and inlets 30a and 30b respectively. Transfer passages 46a and 46b respectively provide this fluid communication with placement of rotary valve 22 in the first position.

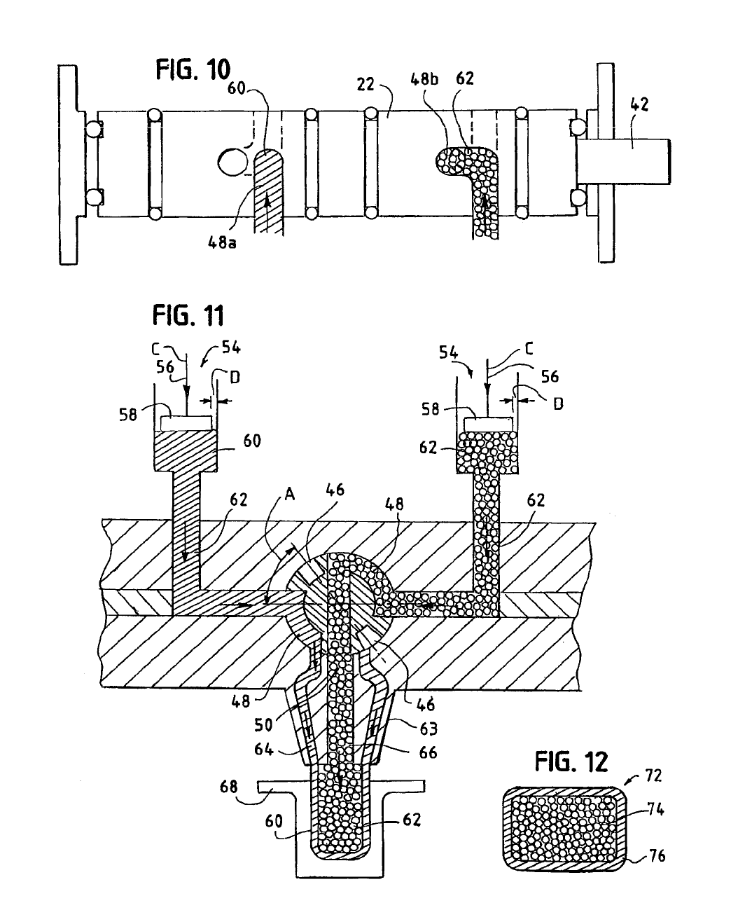

FIGS. 10 and 11 schematically illustrate the rotary valve in the second or depositing position. Downward motion of the pistons in each cylinder as indicated by arrows C subsequently dispenses first and second confectionery 60 and 62 from cylinders 28a and 28b respectively into a coextrusion nozzle 63 when rotary valve 22 is in the second or depositing position as previously discussed. Coextrusion nozzle 63 includes an outer outlet 64 and an inner outlet 66. Inner and outer outlets 64 and 66 are brought into fluid communication with cylinder 28a and 28b respectively by dispensing passages 48a, 48b respectively (FIG. 10) when rotary valve 22 is in the second position. Thus, nozzle 63 deposits first confectionary 60 through outer outlet 64 and second confectionery 62 through inner outlet 66 when rotary valve is in the second position. Nozzle 63 deposits first and second confectioneries 60 and 62 substantially simultaneously thereby coextruding first confectionery 60 with second confectionery 62 to form a coextruded or otherwise laminated confectionery article. In an embodiment, first confectionery 60 encases second confectionery 62 as the two confectioneries are coextruded from nozzle 63 as shown in FIG. 11.

In an embodiment, nozzle 63 deposits streams of first and second confectioneries 60 and 62 into a mold 68 as shown in FIG. 11. In this embodiment, nozzle 63 simultaneously coextrudes confectionery streams 60 and 62. Outlets 64 and 66 may be in a side-by-side arrangement to produce a layered confectionery article. Alternatively, outlets 64 and 66 may be concentric with respect to each other so that confectionery stream 60 from outer outlet 64 encases confectionery stream 62 from inner outlet 66.

In an embodiment, nozzle 63 and mold 68 are configured so that the length of the diameter of mold 68 is substantially the same as the length of the diameter of nozzle end 70. This arrangement prevents swirling or comingling of the confectionery streams 60 and 62 during deposit into mold 68. Provision of mold 68 having substantially the same diameter of nozzle end 70 thereby enables the stream of coextruded first confectionery 60 to encase or otherwise completely surround the stream of coextruded second confectionery 62 to form a wholly coated confectionery article. Alternatively, the diameter of mold 68 may be greater or less than the diameter of nozzle end 70 to form a multi-layered confectionery article having a spiraled, curled, swirled or otherwise textured appearance.

The respective pistons associated with and in operative engagement with cylinders 28a and 28b may be configured to move at different rates during coextrusion of first and second confectioneries 60 and 62 (i.e., when rotary valve 22 is in the second position). FIG. 11 shows confectionery 62 being deposited at a faster rate than confectionery 60 as the piston in cylinder 28b is lower than the piston in cylinder 28a. This varies the amount of first confectionery 60 that is coextruded or otherwise deposited with second confectionery 62. Moreover, varying the rates of the downward piston motion thereby enables apparatus 10 to produce a coextruded laminated confectionery article having layers of varying thickness. In an embodiment, the rates of the piston upstroke may be adjusted so that a different amount of first confectionery 60 is transferred into cylinder 28a when compared to the amount of second confectionery 62 transferred into cylinder 28b. The skilled artisan will further appreciate that the deposit amounts of the first and second confectioneries may also be varied by 1) utilizing different piston diameters for each flowable confectionery, 2) applying different stroke lengths to each flowable confectionery, and 3) utilizing a combination of different piston diameters and different stroke lengths.

A further advantage of the present invention is that the provision of the tight tolerance between piston head 58 and the inner surface of cylinder 28 enables apparatus 10 to accurately deposit small amounts of flowable confectionery. By adjusting the upward distance traveled by the piston as well as the piston downward rate of motion, apparatus 10 may produce coextruded confectionery articles having very thin layers. For example, the piston in operative engagement with cylinder 28a may be configured to move only a short upward distance to transfer a small amount of first confectionery 60 into cylinder 28a compared to the upward distance traveled by the piston associated with cylinder 28b. Moreover, the downstroke piston rate for the piston in operative engagement with cylinder 28a may be slower than the downstroke piston for the piston in operative engagement with cylinder 28b in order to form a confectionery article having a thin uniform outer coating of first confectionery 60 that surrounds a larger inner core of second confectionery 62. The nozzle outlet size and the piston downstroke may be adjusted to deposit very thin single or multiple confectionery layers having substantially uniform thickness. In an embodiment, apparatus 10 may be used to produce confectionery layers having a thickness from about 0.05 mm to about 2.0 mm.

In another embodiment, the present invention provides a confectionery article 72 produced by apparatus 10. Confectionery article 72 includes a core 74 and a coating 76 as shown in FIG. 12. Coating 76 is coextruded to core 74 as previously discussed. Thus, coating 76 may be composed of first flowable confectionery 60 and core 74 may be composed of second flowable confectionery 62. Core 76 may be any confectionery product that is capable of being coated as is commonly known in the art. Nonlimiting examples of materials suitable for core 74 include hard candy, soft candy, chewing gum, jellies, gums, caramel, nut paste, gelatins, fondants, nougats, chocolate, toffee, taffy and any combination thereof. Coating 76 may be any confectionery product that is capable of coating another confectionery product as is commonly known in the art. Nonlimiting examples of materials suitable for coating 76 include hard candy, soft candy, chewing gum, jellies, gums, caramel, nut paste, gelatins, fondants, nougats, chocolate, toffee, taffy and any combination thereof.

The composition of core 74 and coating 76 may be the same or different. In an embodiment, coating 76 is a different confectionery product than core 74. In a further embodiment, coating 76 is substantially continuous and completely encases or otherwise covers or surrounds the entirety of core 74. In a further embodiment, coating 76 has a uniform thickness.

An advantage of the present invention is the capability of apparatus 10 to accurately deposit as well as coextrude uniform layers of flowable confectionery product. The tight tolerance between each piston and respective cylinder provides apparatus 10 with a high degree of accuracy 1) for depositing relatively small amounts of confectionery and 2) for controlling the rate at which the confectionery is deposited. Thus, laminated confectionery articles produced by apparatus 10 may exhibit fine, thin coextruded layers and/or coatings having a uniform thickness. In an embodiment, coating 76 coextruded to core 74 may be present in an amount from about 5% to about 30% by weight of the confectionery article. In a further embodiment, coating 76 may constitute from about 5% to about 10% by weight of the confectionery article. In yet a further embodiment, coating 76 may be from about 0.05 mm to about 2.0 mm thick and has a substantially uniform thickness about the entire confectionery article.

Although FIG. 12 illustrates a confectionery article having a core coated with a single coating, the skilled artisan will appreciate that laminated products with multiple coextruded layers may be produced in accordance with the present invention.

For example, laminated confectionery products having three, four, five, six or more coextruded layers may be produced by apparatus 10. Furthermore, non-coated laminated confectionery articles are also within the scope of the present invention.

Apparatus 10 may be adapted to deposit coextruded streams of flowable confectionery in a layered manner to produce a coextruded multi-layered confectionery article. Alternatively, the layers of confectionery product may be deposited to produce a confectionery article having a swirled appearance.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

### EXAMPLES

TABLE 1
Deposit Amount Based on Piston Diameter and Stroke Length
Confectionery Density (hot mass) 1.27 gr/cm³

| | | | |
|---|---|---|---|
| STROKE (mm) | SECTION (mm2) | VOLUME (cm3) | WEIGHT (g) |

Piston Diameter 6.00 mm.

| | | | |
|---|---|---|---|
| 12.00 | 28.274 | 0.339 | 0.431 |
| 30.00 | 28.274 | 0.848 | 1.077 |

Piston Diameter 7.00 mm.

| | | | |
|---|---|---|---|
| 12.00 | 38.485 | 0.462 | 0.587 |
| 30.00 | 38.485 | 1.155 | 1.466 |

Piston Diameter 8.00 mm.

| | | | |
|---|---|---|---|
| 12.00 | 28.274 | 0.339 | 0.431 |
| 30.00 | 50.265 | 1.508 | 1.915 |

Piston Diameter 9.00 mm.

| | | | |
|---|---|---|---|
| 12.00 | 63.617 | 0.763 | 0.970 |
| 30.00 | 63.617 | 1.909 | 2.424 |

Piston Diameter 10.00 mm.

| | | | |
|---|---|---|---|
| 12.00 | 78.540 | 0.942 | 1.197 |
| 30.00 | 78.540 | 2.356 | 2.992 |

Piston Diameter 11.00 mm.

| | | | |
|---|---|---|---|
| 12.00 | 95.033 | 1.140 | 1.448 |
| 30.00 | 95.033 | 2.851 | 3.621 |

Piston Diameter 12.00 mm.

| | | | |
|---|---|---|---|
| 12.00 | 113.097 | 1.357 | 1.724 |
| 30.00 | 113.097 | 3.393 | 4.309 |

Piston Diameter 13.00 mm.

| | | | |
|---|---|---|---|
| 12.00 | 132.732 | 1.593 | 2.023 |
| 30.00 | 132.732 | 3.982 | 5.057 |

Piston Diameter 14.00 mm.

| | | | |
|---|---|---|---|
| 12.00 | 153.938 | 1.847 | 2.346 |
| 30.00 | 153.938 | 4.618 | 5.865 |

TABLE 2
Confectionary Article Example 1

| CONFECTIONERY ARTICLE | | | SAME PISTON STROKE, DIFFERENT PISTON DIAMETERS | | | | | | |
|---|---|---|---|---|---|---|---|---|---|
| EXAMPLE 1 | | | (7 mm PISTON for 20% SHELL AND 14 mm PISTON for 80% CORE) | | | | | | |
| Diameter of the piston A (shell) | 7 | mm. | Tolerance | From | 7 − 0.005 | to | 7 − 0.014 | Maximum gap | 0.029 |
| | | | | | | | | acceptable | |
| Diameter of the cylinder A (shell) | 7 | mm. | Tolerance | From | 7 + 0.015 | to | 7 − 0.000 | Minimum gap | 0.005 |
| | | | | | | | | acceptable | |
| Weight of the shell (20%) | 0.600 | gr. | | | | | | | |
| Stroke of piston A | 12.27 | mm. | Volume | 0.00047 | Cubic decimeters | | | | |
| Density of the candy mass | 1.27 | Kg/dm3 | Weight | 0.600 | grams | | | | |
| Diameter of the piston B (core) | 14 | mm. | Tolerance | From | 14 − 0.006 | to | 14 − 0.017 | Maximum gap | 0.035 |
| | | | | | | | | acceptable | |
| Diameter of the cylinder B (core) | 14 | mm. | Tolerance | From | 14 + 0.018 | to | 14 − 0.000 | Minimum gap | 0.006 |
| | | | | | | | | acceptable | |
| Weight of the core (80%) | 2.400 | gr. | | | | | | | |

| | | | | | |
|---|---|---|---|---|---|
| Stroke of piston B | 12.27 | mm. | Volume | 0.00189 | Cubic decimeters |

| | | | | | |
|---|---|---|---|---|---|
| Density of the candy mass | 1.27 | Kg/dm3 | Weight | 2.400 | grams |

Volume = stroke × diameter × diameter × pi/4
Weight = Volume × density

TABLE 3
Confectionary Article Example 2

| CONFECTIONERY ARTICLE | | | SAME PISTON DIAMETER, DIFFERENT PISTON STROKES | | | | | | |
|---|---|---|---|---|---|---|---|---|---|
| EXAMPLE 2 | | | (12 mm STROKE FOR 30% SHELL AND 70% CORE) | | | | | | |
| Diameter of the piston A (shell) | 12 | mm. | Tolerance | From | 12 − 0.006 | to | 7 − 0.017 | Maximum gap | 0.035 |
| | | | | | | | | acceptable | |
| Diameter of the cylinder A (shell) | 12 | mm. | Tolerance | From | 12 + 0.018 | to | 12 − 0.000 | Minimum gap | 0.006 |
| | | | | | | | | acceptable | |
| Weight of the shell (20%) | 0.900 | gr. | | | | | | | |
| Stroke of piston A | 6.3 | mm. | Volume | 0.00071 | Cubic decimeters | | | | |
| Density of the candy mass | 1.27 | Kg/dm3 | Weight | 0.900 | grams | | | | |
| Diameter of the piston B (core) | 12 | mm. | Tolerance | From | 12 − 0.006 | to | 7 − 0.017 | Maximum gap | 0.035 |
| | | | | | | | | acceptable | |
| Diameter of the cylinder B (core) | 12 | mm. | Tolerance | From | 12 + 0.018 | to | 12 − 0.000 | Minimum gap | 0.006 |
| | | | | | | | | acceptable | |
| Weight of the core (80%) | 2.100 | gr. | | | | | | | |

| | | | | | |
|---|---|---|---|---|---|
| Stroke of piston B | 14.6 | mm. | Volume | 0.00165 | Cubic decimeters |

| | | | | | |
|---|---|---|---|---|---|
| Density of the candy mass | 1.27 | Kg/dm3 | Weight | 2.100 | grams |

Volume = stroke × diameter × diameter × pi/4
Weight = Volume × density

TABLE 4
Candy Drops

| | RAW MATERIAL | WEIGHT (0) | (%) | | |
|---|---|---|---|---|---|
| Shell | Cooked Mass | 2000.00 | 99.34% | | |
| | Menthol | 10.05 | 0.50% | | |
| | 2% Color Solution | 2.00 | 0.10% | | |
| | Lemon A | 1.20 | 0.060% | | |
| | TOTAL | 2013.25 | 100.00% | | |
| Center | Cooked Mass | 2000.00 | 98.50% | | |
| | Menthol | 2.00 | 0.10% | | |
| | Lemon B | 28.40 | 1.40% | | |
| | TOTAL | 2030.40 | 100.00% | | |
| | RAW MATERIAL | WEIGHT (g) | % (OUT) | % (IN) | DRY S. (%) |
| Sugar/Corn Syrup - Cooked Mass | Sugar | 3000.00 | 53.14% | 42.86% | 99.90% |
| | Corn Syrup | 3000.00 | 53.31% | 42.86% | 83.00% |
| | Water | 1000.00 | 17.77% | 14.29% | 0.00% |
| | TOTAL Initial | 7000.00 | 124.38% | 100.00% | 78.39% |
| | WATER LOSS | −1372.31 | −24.38% | | |
| | TOTAL final | 5627.69 | 100.00% | | 97.50% |
| | RAW MATERIAL | WEIGHT (g) | % | | DRY S. (%) |
| Color Solution - 2% (concentration) | Water | 98.00 | 98.00% | | 0.00% |
| | Green Color | 2.00 | 2.00% | | 99.00% |
| | TOTAL | 100.00 | 100.00% | | |
| | RAW MATERIAL | % | | | |
| Grouped Recipe - Finished Product | Sugar | 53.31% | | | |
| | HMCS 42 DE/Corn Syrup | 53.31% | | | |
| | Menthol | 0.60% | | | |
| | 2% Color Solution | 0.10% | | | |
| | Flavor Lemon B | 1.40% | | | |
| | Flavor Lemon A | 0.06% | | | |
| | Water | −8.77% | | | |
| | TOTAL | 100.00% | | | |

TABLE 5
Filled Hard Candy

| SHELL CARAMEL RAW | | | | | |
|---|---|---|---|---|---|
| MATERIAL | G | % | | | |
| Cooked Mass | 1982.609 | 99.30% | | | |
| Color Solution | 10.000 | 0.501% | | | |
| Titanium Dioxide | 4.000 | 0.20% | | | |
| TOTAL | 1996.609 | 100.00% | | | |
| FILLING CARAMEL RAW | | | | | |
| MATERIAL | g | % | | | |
| Cooked Mass | 5947.626 | 99.77% | | | |
| Titanium Dioxide | 14.000 | 0.23% | | | |
| TOTAL | 5961.826 | 100.00% | | | |
| SUGAR SOLUTION RAW | | | | 145° C. 0.1 bar | |
| MATERIAL | g | % (OUT) | % (IN) | DRY MATTER | (M.S.) |
| Sugar | 4300.000 | 54.22% | 42.74% | 99.90% | 55% |
| HMCS 38 DE/Corn Syrup | 4300.000 | 54.22% | 42.74% | 82.50% | 45% |
| Deionized Water | 1460.000 | 18.41% | 14.51% | 0.00% | |
| TOTAL | 10060.090 | 128.85% | 100.00% | 77.96% | |
| WATER LOSS | −2129.565 | 31 28.85% | | | |
| TOTAL | 7930.435 | 100.00% | | 99.90% | |
| Solution | | | | | |
| RAW MATERIAL | g | & (on final) | | DRY S. | |
| Dry Color | 0.400 | 4.00% | | 99.00% | |
| Water | 9.600 | 96.00% | | 0.00% | |
| TOTAL | 10.000 | 100.00% | | 3.96% | |
| GROUPED RECIPE FINISHED | | | | | |
| PRODUCT: | | | | | |
| RAW MATERIAL | 5 | | | | |
| Sugar | 54.031% | SHELL 25.00% | | | |
| | | FILLING 75.00% | | | |
| Glucose HM 4580 | 54.031% HMCS | | | | |
| Brilliant Black solution | 0.125% | | | | |
| Titanium Dioxide 50% | 0.226% | | | | |
| Water | −6.413% | | | | |
| TOTAL | 100.000% | | | | |

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-39. (canceled)

40. A confectionery article comprising:
a core coextruded to a coating, the coating present in an amount from about 5% to about 30% by weight of the confectionery article.

41. The article of claim 40 wherein the coating is substantially continuous.

42. The article of claim 40 wherein the coating encases the entire core.

43. The article of claim 40 wherein the core is composed of a component selected from the group consisting of hard candy, soft candy, chewing gum, jellies, gums, caramel, nut paste, gelatins, fondants, nougats, chocolate, toffee, taffy and combinations thereof.

44. The article of claim 40 wherein the coating is selected from a component selected from the group consisting of hard candy, soft candy, chewing gum, jellies, gums, caramel, nut paste, gelatins, fondants, nougats, chocolate, toffee, taffy and combinations thereof.

45. The article of claim 40 wherein the composition of the core is different than composition of the coating.

46. The article of claim 40 wherein the coating is present from about 5% to about 10% by weight.

47. The article of claim 40 wherein the coating has a thickness of about 0.05 mm to about 2.0 mm.
